(19) United States
(12) Patent Application Publication
(10) Pub. No.: US 2004/0170211 A1
(43) Pub. Date: Sep. 2, 2004

(54) Thermal management utensil system

(76) Inventor: Erin E. Paul, Hagerstown, MD (US)

Correspondence Address: Michael S. Neustel, Suite No. 4, 2534 South University Drive, Fargo, ND, 58103, US

(21) Appl. No.: 10/377,235

(22) Filed: Feb. 27, 2003

(51) Int. Cl. G01K 1/00

(52) U.S. Cl. 374/100

(57) ABSTRACT

A thermal management utensil system for cooling food and beverages to a desirable temperature without diluting them. The thermal management utensil system includes an elongate handle member, a scoop member attached to the handle member, a reservoir within the scoop member and a volume of coolant within the reservoir. The handle member is preferably comprised of an insulating material.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to eating utensils and more specifically it relates to a thermal management utensil system for cooling food and beverages to a desirable temperature without diluting them.

2. Description of the Related Art

Eating utensils have been in use for years such as but not limited to forks, spoons, knives and the like. Eating utensils are utilized to manipulate and eat food such as but not limited to beverages (e.g. coffee, tea, hot chocolate), soups, casseroles, stews and the like.

A common problem experienced by individuals eating heated food or beverages is that the food item may be at a temperature higher than desired. In some instances, the food item may be at a temperature that may cause physical damage to an individual through scalding and the like. Some individuals choose to “water down” the food item with cool water or the like which only dilutes the food item reducing the flavor. Hence, there is a need for a product that will assist an individual in reducing the temperature of a food item without diluting the food item.

Examples of patented devices which may be related to the present invention include U.S. Pat. No. 1,944,726 to Aiken; U.S. Pat. No. 2,120,201 to Fisk; U.S. Pat. No. 2,181,697 to Kavalir; U.S. Pat. No. 2,462,757 to Loycz; U.S. Pat. No. 2,591,375 to Radford; U.S. Pat. No. 2,688,467 to Leatzow; U.S. Pat. No. 4,325,230 to Driscoll et al.; U.S. Pat. No. 4,735,063 to Brown; U.S. Pat. No. 4,943,836 to Childers; and U.S. Pat. No. 6,182,452 to Wright et al.

While these devices may be suitable for the particular purpose to which they address, they are not as suitable for cooling food and beverages to a desirable temperature without diluting them. Conventional methods of cooling food items involve diluting the food items with water or similar material that dilutes the food item.

In these respects, the thermal management utensil system according to the present invention substantially departs from the conventional concepts and designs of the prior art, and in so doing provides an apparatus primarily developed for the purpose of cooling food and beverages to a desirable temperature without diluting them.

### BRIEF SUMMARY OF THE INVENTION

In view of the foregoing disadvantages inherent in the known types of eating utensils now present in the prior art, the present invention provides a new thermal management utensil system construction wherein the same can be utilized for cooling food and beverages to a desirable temperature without diluting them.

The general purpose of the present invention, which will be described subsequently in greater detail, is to provide a new thermal management utensil system that has many of the advantages of the eating utensils mentioned heretofore and many novel features that result in a new thermal management utensil system which is not anticipated, rendered obvious, suggested, or even implied by any of the prior art eating utensils, either alone or in any combination thereof.

To attain this, the present invention generally comprises an elongate handle member, a scoop member attached to the handle member, a reservoir within the scoop member and a volume of coolant within the reservoir. The handle member is preferably comprised of an insulating material.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a thermal management utensil system that will overcome the shortcomings of the prior art devices.

A second object is to provide a thermal management utensil system for cooling food and beverages to a desirable temperature without diluting them.

Another object is to provide a thermal management utensil system that does not reduce or change the flavor or texture of the food item.

An additional object is to provide a thermal management utensil system that may be utilized with various types of heated foods such as but not limited to beverages (e.g. coffee, tea, hot chocolate), soups, casseroles, stews and the like.

A further object is to provide a thermal management utensil system that allows the user to quickly reduce the temperature of the food item.

Another object is to provide a thermal management utensil system that may be positioned within a refrigerator or freezer.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a top view of the present invention.

FIG. 3 is a cross sectional view taken along line 3-3 of FIG. 2 illustrating the coolant reservoir.

FIG. 4 is a side view of the present invention.

FIG. 5 is a cross sectional view taken along line 5-5 of FIG. 2.

### DETAILED DESCRIPTION OF THE INVENTION

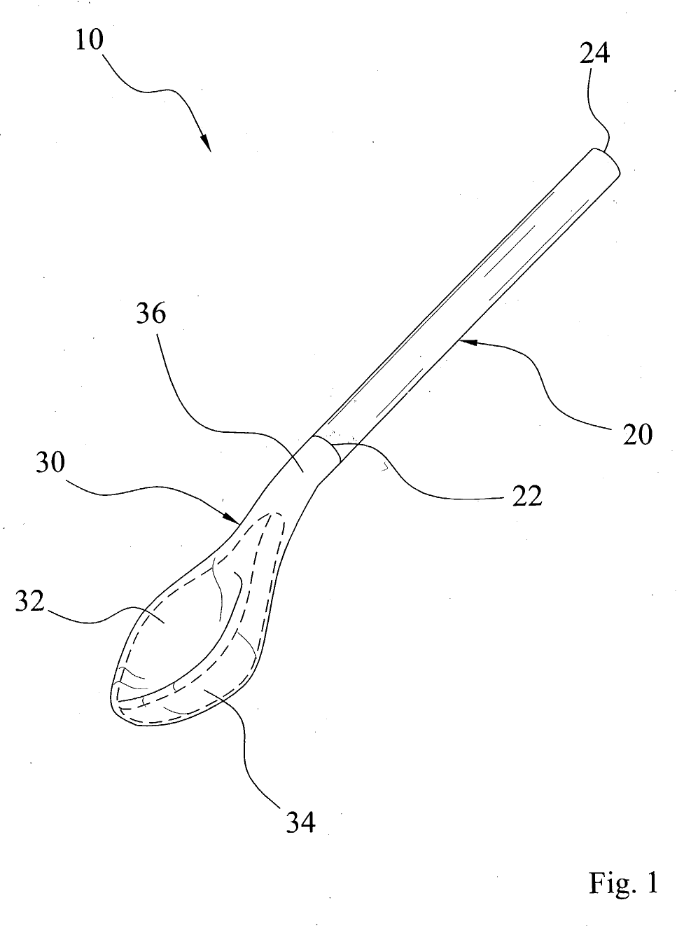

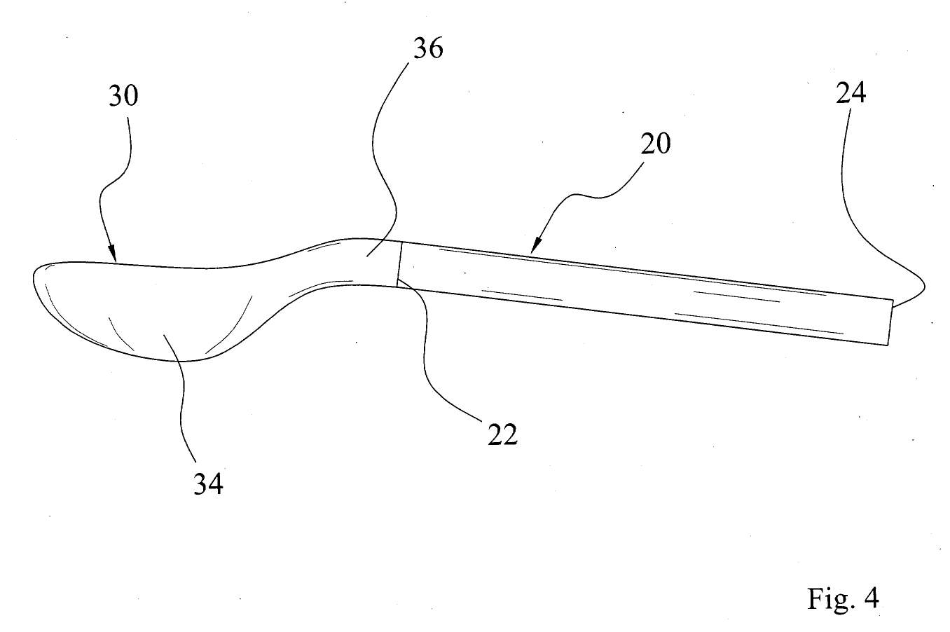

Turning now descriptively to the drawings, in which similar reference characters denote similar elements throughout the several views, FIGS. 1 through 5 illustrate a thermal management utensil system 10, which comprises an elongate handle member 20, a scoop member 30 attached to the handle member 20, a reservoir 38 within the scoop member 30 and a volume of coolant 40 within the reservoir 38. The handle member 20 is preferably comprised of an insulating material.

As shown in FIGS. 1, 2, 4 and 5 of the drawings, the handle member 20 has an elongate structure having a first end 22 and a second end 24. The handle member 20 may have various cross sectional shapes such as but not limited to circular, square, rectangular, flat and the like. The handle member 20 may have a straight structure as shown in FIGS. 1, 2, 4 and 5 of the drawings, or the handle member 20 may have an ergonomic design.

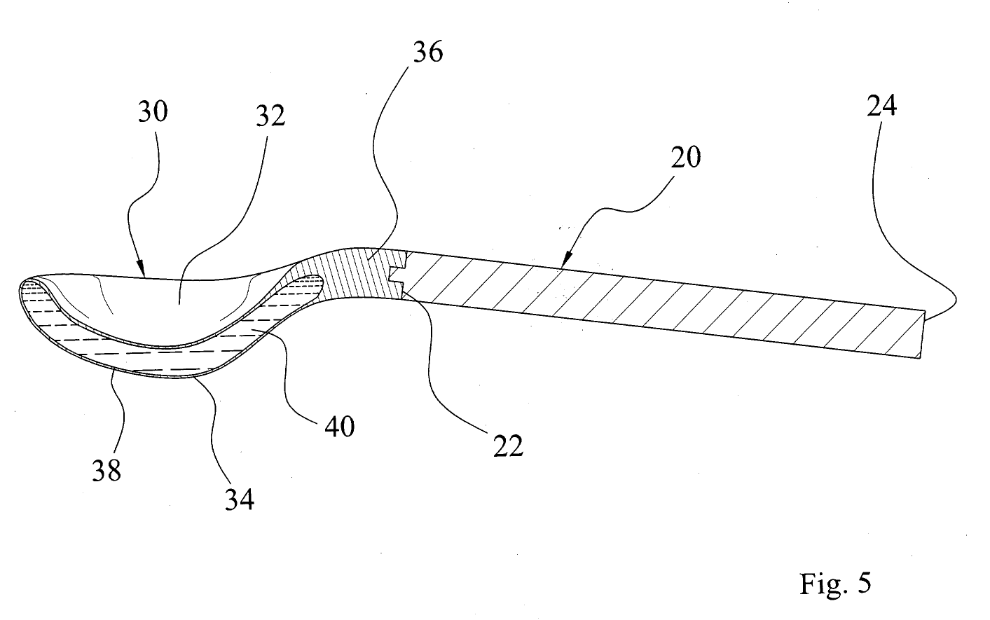

The first end 22 of the handle member 20 is attached to the neck portion 36 of the scoop member 30 as best illustrated in FIG. 5 of the drawings. The first end 22 of the handle member 20 preferably has an extended tongue portion that is received within an aperture within the end of the neck portion 36 as further shown in FIG. 5 of the drawings. The first end 22 of the handle member 20 may be secured to the neck portion 36 of the scoop member 30 by a conventional adhesive, glue, fastener or other fastening device.

The handle member 20 is preferably comprised of an insulating material to reduce the conduction of heat from the user's hand during grasping. The handle member 20 may be comprised of a plastic or composite material preferably having the insulating characteristics. In addition, the handle member 20 may have an outer insulating layer to protect the user that may be comprised of a layer of foam rubber or the like.

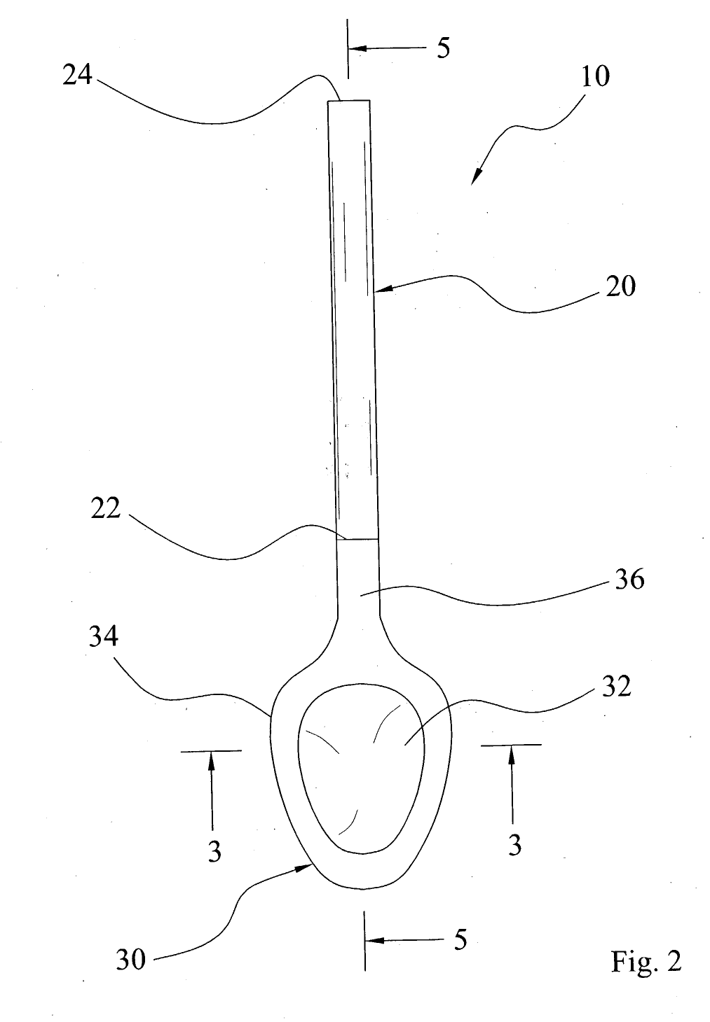

The scoop member 30 is shaped similar to the head of a conventional spoon as best illustrated in FIGS. 1 and 2 of the drawings. The scoop member 30 preferably has a recessed bowl portion 32 for receiving the food item. The scoop member 30 further includes an outer portion 34 that is attached to the bowl portion 32 to form a reservoir 38 as shown in FIGS. 1, 3 and 5 of the drawings. The scoop member 30 is preferably comprised of a highly heat conductive material such as but not limited to metal.

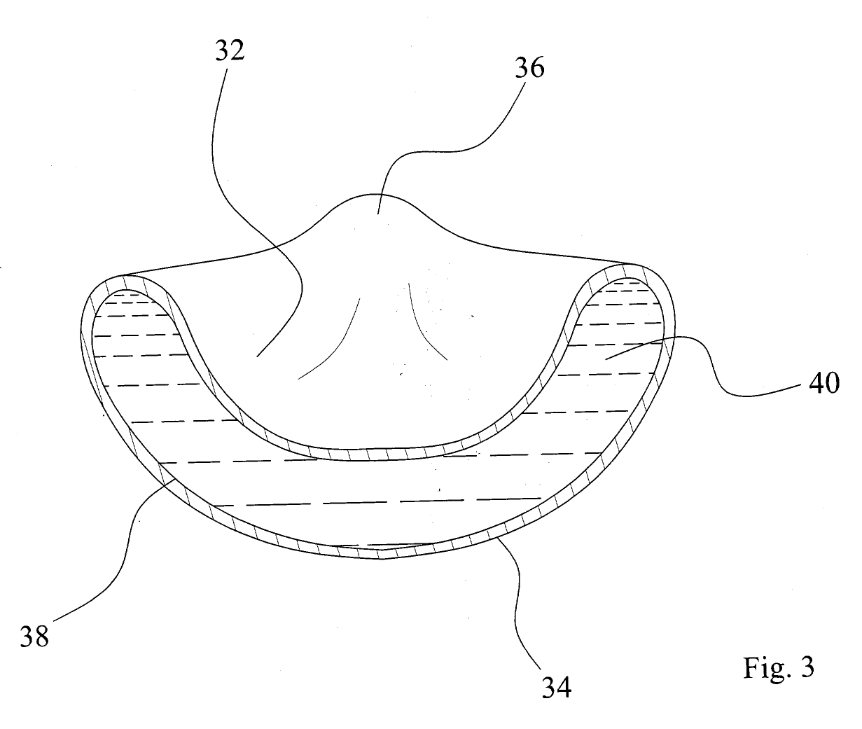

The reservoir 38 preferably extends from the lower most center of the scoop member 30 to the upper most side portions of the scoop member 30 as best illustrated in FIG. 3 of the drawings. The reservoir 38 preferably has a C-shaped cross sectional area from the front and side as illustrated in FIGS. 3 and 5 of the drawings. The reservoir 38 is formed for receiving a volume of coolant 40 that is preferably in a liquid state at room temperature. The coolant 40 may be comprised of various liquids capable of being chilled without significant expansion thereof even if frozen. The neck portion 36 is preferably a tapered solid structure that has an aperture that receives the first end 22 of the handle member 20 as shown in FIGS. 1 through 5 of the drawings.

In use, the user positions the thermal management utensil system 10 within a cooling unit such as a refrigerator or freezer. After a period of time, the coolant 40 within the scoop member 30 becomes chilled to a cold temperature and possibly to a solid frozen state. When the user desires to cool a food item such as coffee, the user simply removes the thermal management utensil system 10 from the cooling unit and inserts the scoop member 30 into the food item. The scoop member 30 and the coolant 40 then conduct the heat from the food item as the user manipulates the scoop member 30 with the handle member 20 within the food item. When the food item is cooled to the desired temperature, the thermal management utensil system 10 is then removed from the food item, cleaned and then repositioned within the cooling unit for later use.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A thermal management utensil system, comprising:
a handle member having an elongate structure;
an engaging member attached to said handle member;
a reservoir within said engaging member; and
a volume of coolant positioned within said reservoir.

2. The thermal management utensil system of claim 1, wherein said engaging member is comprised of a scoop structure.

3. The thermal management utensil system of claim 2, wherein said engaging member has a bowl portion and an outer portion connected together surrounding said reservoir.

4. The thermal management utensil system of claim 3, wherein said engaging member includes a neck portion connected to a first end of said handle member.

5. The thermal management utensil system of claim 4, wherein said neck portion has a tapered structure.

6. The thermal management utensil system of claim 5, wherein said neck portion has a solid structure.

7. The thermal management utensil system of claim 3, wherein said reservoir extends from a center lower portion to opposing side upper portions of said engaging member.

8. The thermal management utensil system of claim 7, wherein said reservoir has a C-shaped cross sectional shape.

9. The thermal management utensil system of claim 1, wherein said handle member has a tongue portion extending from a first end of said handle member that mates with an aperture within a neck portion of said engaging member.

10. The thermal management utensil system of claim 1, wherein said handle member is integrally formed with said engaging member.

11. A thermal management utensil system, comprising:
a handle member having an elongate structure, wherein said handle member is comprised of an insulating material;
an engaging member attached to said handle member forming a spoon shaped structure, wherein said engaging member is comprised of a heat conductive material;
a reservoir within said engaging member; and
a volume of coolant positioned within said reservoir.

12. The thermal management utensil system of claim 11, wherein said engaging member is comprised of a scoop structure.

13. The thermal management utensil system of claim 12, wherein said engaging member has a bowl portion and an outer portion connected together surrounding said reservoir.

14. The thermal management utensil system of claim 13, wherein said engaging member includes a neck portion connected to a first end of said handle member.

15. The thermal management utensil system of claim 14, wherein said neck portion has a tapered structure.

16. The thermal management utensil system of claim 15, wherein said neck portion has a solid structure.

17. The thermal management utensil system of claim 13, wherein said reservoir extends from a center lower portion to opposing side upper portions of said engaging member.

18. The thermal management utensil system of claim 17, wherein said reservoir has a C-shaped cross sectional shape.

19. The thermal management utensil system of claim 11, wherein said handle member has a tongue portion extending from a first end of said handle member that mates with an aperture within a neck portion of said engaging member.

20. A method of operating a thermal management utensil comprised of a handle member having an elongate structure, wherein said handle member is comprised of an insulating material, an engaging member attached to said handle member forming a spoon shaped structure, wherein said engaging member is comprised of a heat conductive material, a reservoir within said engaging member, and a volume of coolant positioned within said reservoir, said method comprising:
(a) positioning said thermal management utensil within a cooling unit for a period of time;
(b) providing a food item in a heated state;
(c) removing said thermal management utensil from said cooling unit;
(d) positioning said engaging member said thermal management utensil within said food item;
(e) manipulating said thermal management utensil until said food item is reduced in temperature to a desired temperature; and
(f) removing said thermal management utensil from said food item.
